(19) United States
(12) Patent Application Publication
(10) Pub. No.: US 2025/0368498 A1
(43) Pub. Date: Dec. 4, 2025

(54) System and Method for Dispensing Fluid Cleanly Using Compression and Negative Pressure

(71) Applicant: Jason H Andersen, Meridian, ID (US)

(72) Inventor: Jason H Andersen, Meridian, ID (US)

(73) Assignee: FTE2, Meridian, ID (US)

(21) Appl. No.: 18/732,340

(22) Filed: Jun. 3, 2024

(51) Int. Cl. B67D 7/34; B60K 15/04; B67D 7/12

(52) U.S. Cl. CPC B67D 7/342; B60K 15/04; B67D 7/12; B60K 2015/0477

(57) ABSTRACT

A system and method for dispensing fluid from a reservoir cleanly using compression and negative pressure is disclosed. The system (herein referred to as ‘System”) is essentially comprised of a nozzle and a portable fluid jug (herein referred to as a ‘reservoir’). Two embodiments have a nozzle with a compression portion that when pushed against a tank neck allows fluid to flow from the reservoir. When the tank is full, fluid reaches the nozzle and blocks an internal vent line within the nozzle. This blockage builds negative pressure inside the reservoir, subsequently halting the flow of fluid through the nozzle. An object of the System is to allow fluid to flow quickly and cleanly into a fluid tank (such as those on vehicles, motor cycles, small engines, etc.) Other objects, details and embodiments of the System will be examined in further sections of this disclosure.

### FIELD OF THE INVENTION

The present invention generally relates to fluid transfer. More specifically, it relates to a system and method for dispensing fluid from a jug cleanly using compression and negative pressure.

### BACKGROUND

The history of fluid cans and fluid jugs is rooted in the early 20th century and was driven by the logistical demands of military operations. The most significant development occurred in the 1930s with the introduction of the “jerrycan” by the Germans. This design featured a robust, leak-proof construction with a built-in spout for easy pouring, a wide mouth for quick filling, and handles for easy carrying and stacking. The Allies quickly adopted the jerrycan during World War II, recognizing its superior functionality over previous fluid storage methods. Post-war, the jerrycan influenced the design of civilian fluid containers, leading to the development of various metal and plastic cans and jugs used for personal, agricultural, and industrial purposes. Despite the evolution in design, fluid cans and jugs continue to present challenges. Even with modern improvements, they can be messy and prone to spills. Poor handling, defective spouts, or improper seals can lead to fluid leakage. Such spills are not only wasteful but also pose significant hazards. Gasoline, being highly flammable, can create fire and explosion risks, particularly in environments where there are ignition sources. Additionally, fluid spills can cause environmental damage, contaminating soil and water bodies, which can have long-lasting effects on ecosystems. The vapors from spilled fluid are harmful to breathe, contributing to air pollution and posing health risks. While modern fluid cans and jugs are designed to be more user-friendly and safer than their predecessors, the potential for spills and the associated hazards remain substantial concerns that necessitate careful handling and proper usage. Modern gasoline pumps often employ automatic shutoff technology as observed in U.S. Pat. Nos. 4,709,735A, 5,127,451A, 4,429,725A, 3,638,689A and Korean Patent KR20110124703. The portable fluid container industry has developed several nozzles that control flow using internal vents and trigger assemblies including United States patents US20090090745A1, U.S. Pat. Nos. 8,800,826B2, 8,038,035B2, and 7,621,304B2. However, these disclosures do not include a compression flow and automatic stop flow features. What is needed is a simple method of dispensing fluid from a portable jug to a tank whereby a user's hands are focused on holding the jug rather than fiddling with nozzle contraptions while dispensing.

### SUMMARY OF THE INVENTION

The device herein disclosed and described provides a solution to the shortcomings in the prior art through the disclosure of a System for dispensing fluid using compression and negative pressure. An object of the System is to allow fluid to transfer from a container to a tank easily. The System nozzle has a compression portion that allows fluid to flow only when the nozzle is compressed against a fluid tank neck.

Another object of the System is to automatically halt the transfer of fluid to a tank automatically. When fluid inside the tank reaches the nozzle and is full, it blocks an internal vent tube inside the nozzle and generates negative pressure inside the jug. This negative pressure automatically halts the flow of fluid from the nozzle into the tank.

Another object of the System is to allow fluid to be transferred into tanks faster than conventional gas cans. The internal vent tube inside the nozzle continues from the tip of the nozzle all the way to the bottom of the container, thereby allowing for faster pressure equalization within the jug which allows gravity to act more swiftly to push fluid into the tank during delivery.

Another object of the System is to provide for greater ergonomics than conventional jugs. The System includes a handle that is configured into the vertical axis of the reservoir allowing for a smaller pouring angle and less strain on the wrist and forearm.

Another object of the System is to provide a means to easily seal the container when not in use. Because the System requires the user to compress the nozzle to allow for flow, the default position is closed and the user does not have to seal the jug with a conventional screw cap after dispensing is complete.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of a first embodiment being used on a vehicle gas tank.

FIG. 2 shows a perspective view of a second embodiment being used on a small engine gas tank.

FIG. 3 shows a close up, top perspective view of a first embodiment of the System.

FIG. 4 shows a close up, top perspective view of a second embodiment of the System.

FIG. 5 shows an exploded view of a first embodiment of the System.

FIG. 6 shows an exploded view of a second embodiment of the System.

FIG. 6A shows an exploded view of a third embodiment of the System.

FIG. 7 shows a representative view of the System method.

Other aspects of the present invention shall be more readily understood when considered in conjunction with the accompanying drawings, and the following detailed description, neither of which should be considered limiting.

### DETAILED DESCRIPTION OF THE FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

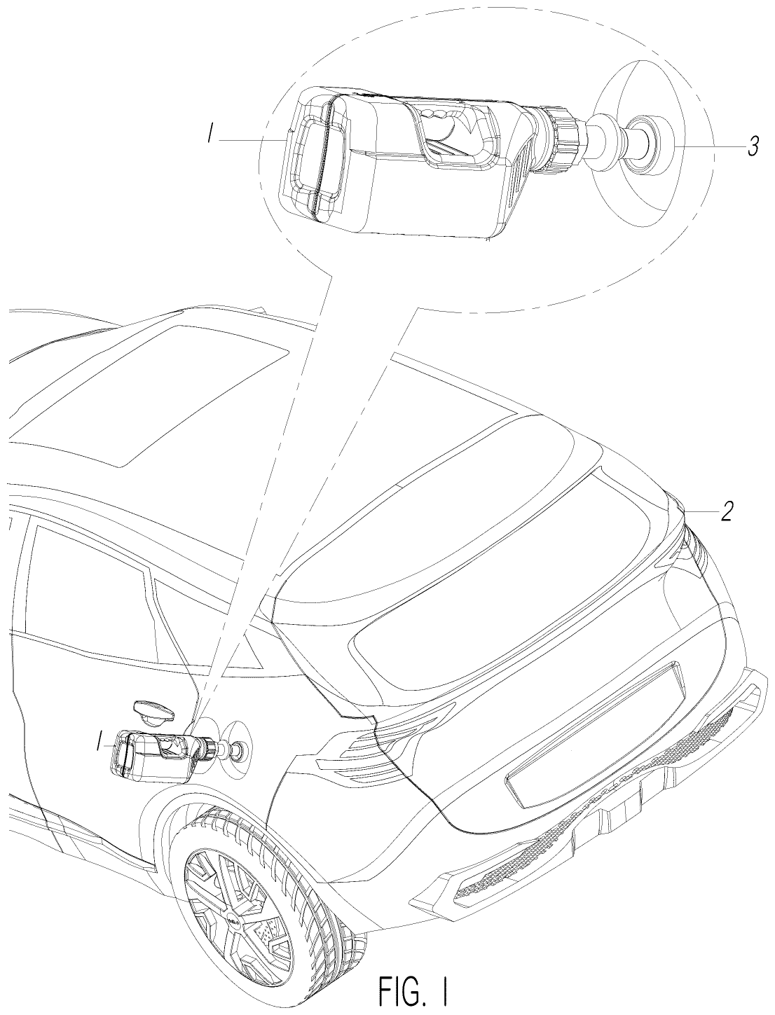

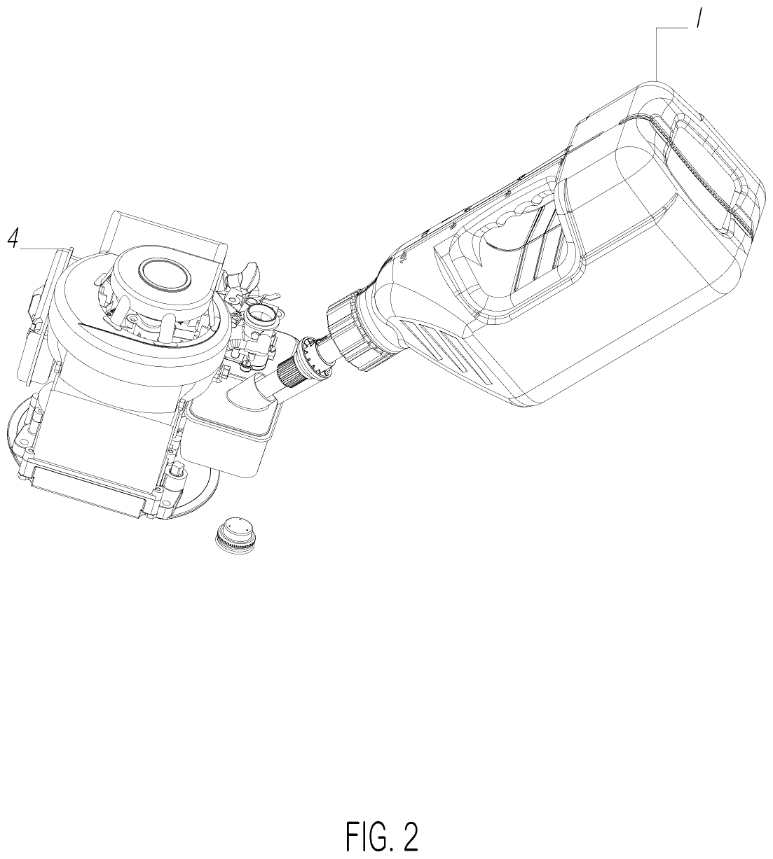

FIG. 1 shows a perspective view of a first embodiment of the System 1 being used on a vehicle's 2 gas tank. The first embodiment having a large diameter nozzle 1A that allows the System 1 to fit inside a standard vehicle gas tank neck 3. FIG. 2 shows a perspective view of a second embodiment of the System 1 having a small nozzle 1A that allows the System press against a standard gas tank neck on a small engine 4. In both embodiments, the System's 1 reservoir 7 having the shape of a conventional gas jug with a handle 1B mounted along the longitudinal axis of reservoir 7 for proper ergonomics. Said nozzle 1A and reservoir 7 being made of a rigid material including but not limited to plastic and the like on both embodiments.

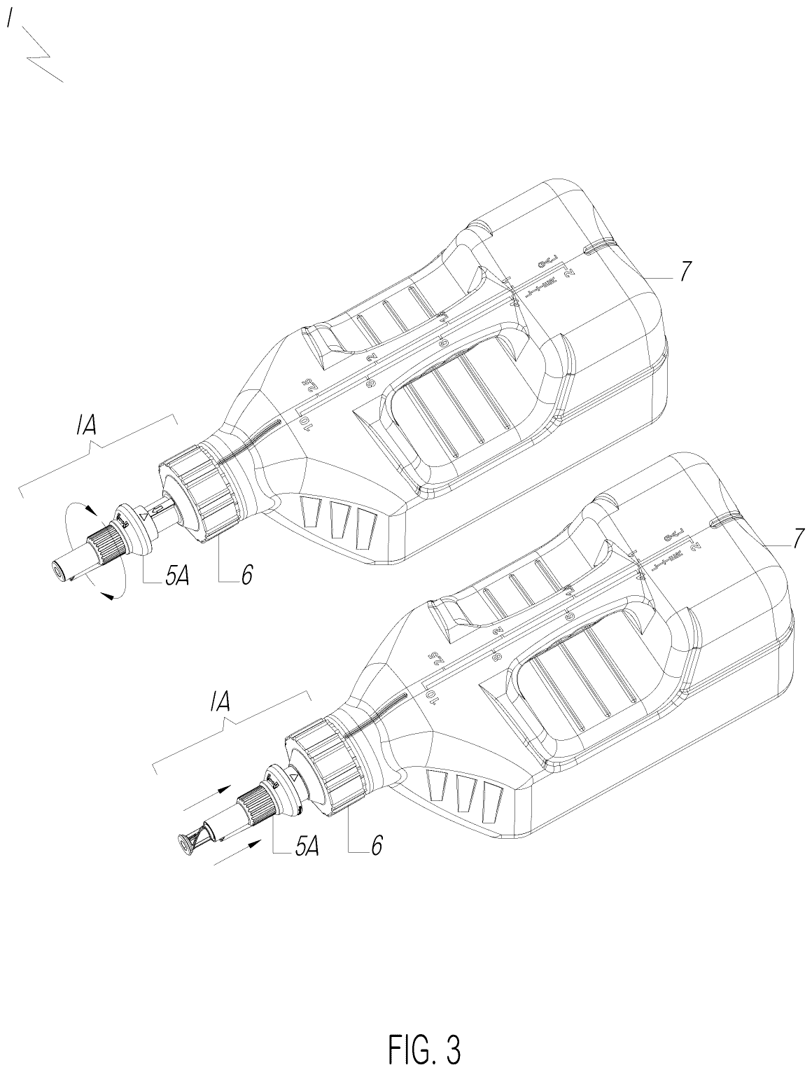

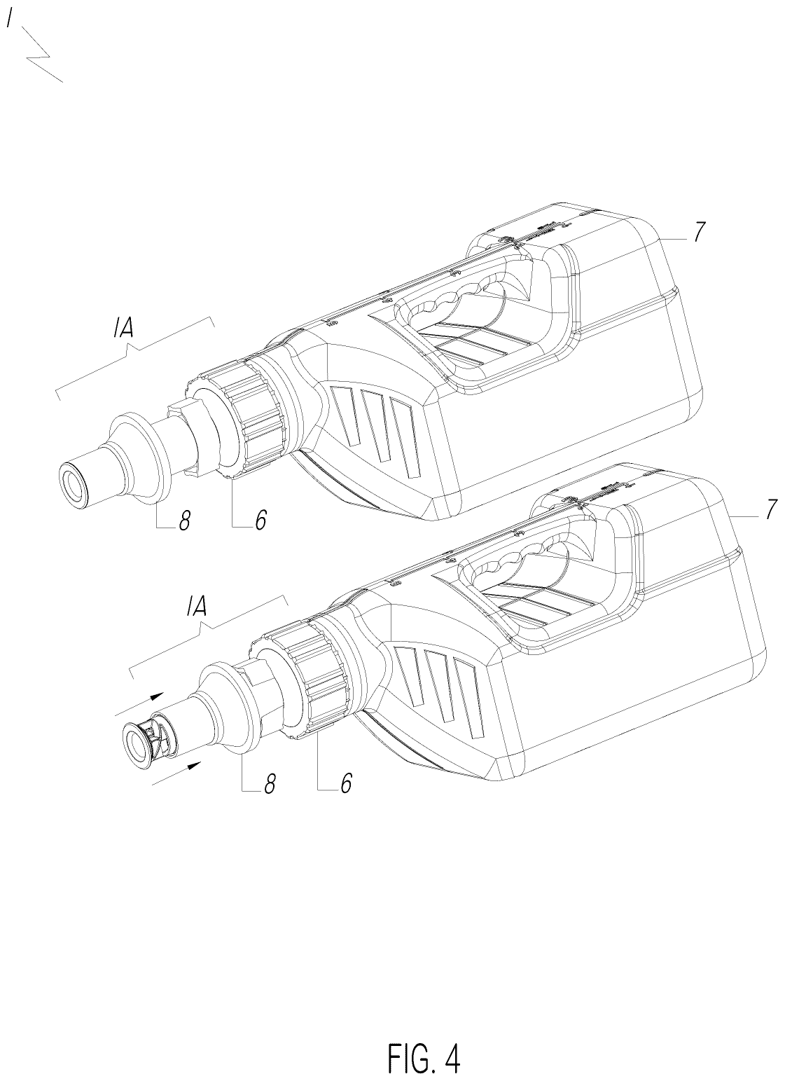

FIG. 3 shows close up, top perspective view of a first embodiment of the System 1 wherein compression collar 5 pivotably engaging reservoir coupling 6 in alignment that allows it to then be compressed onto said reservoir coupling 6 and allowing fluid to flow out of reservoir 7 and air to equalize pressure therein. When fluid fills a tank, the level reaching nozzle 1A and preventing air from equalizing reservoir 7 and halting flow (described further in this disclosure). FIG. 4 shows a close up, top perspective view of a second embodiment of the System 1 having squeeze ring 14 that when squeezed, allows a user to slide compression collar 5 onto reservoir coupling 6 and allowing fluid to flow out of reservoir 7 and air to equalize pressure therein. When fluid fills a tank and the level reaching nozzle 1A, it prevents air from equalizing reservoir 7 and halting flow (described further in this document).

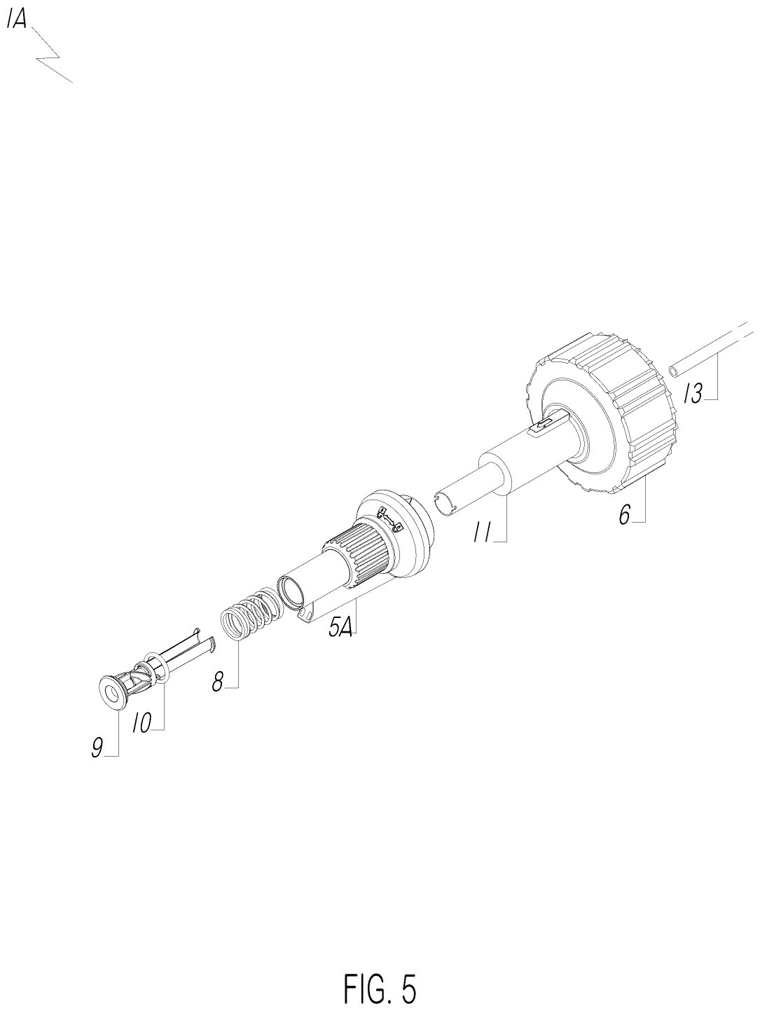

FIG. 5 shows an exploded view of a first embodiment of the System 1 comprised of, but not limited to cylindrical-shaped stopper 9 with hooks on a distal end engaging metal spring 8 there inside along with O-ring 10. Twist flange 5A engaging said stopper 9, O-ring 10 and spring 8 and having a grip relief and push tab that engages tank necks that when compressed allows apertures in stopper 9 to be exposed for fluid flow and air equalization as mentioned. The twist flange 5A being slidably connected to reservoir coupling 6 by means of center support 11 and having a hook-shaped push tab that engages the neck of a tank allowing for compression. When indicia on said twist flange 5A aligns with indicia on center support 11, twist flange 5A it can be slid onto center support 11 by means of an internal slot thereby exposing stopper 9 to be exposed as mentioned. Stopper 9, twist flange 5A and center support 11 are affixed to reservoir 7 by means of compression collar 5. Compression collar 5 is affixed to reservoir 7 with internal threads that engage external threads on said reservoir 7. Vent tube 13 is configured within all components and affixed to one of stopper 9's apertures. When fluid fills a tank, the level reaching apertures in stoper 9 and preventing air from equalizing reservoir 7 and halting flow automatically.

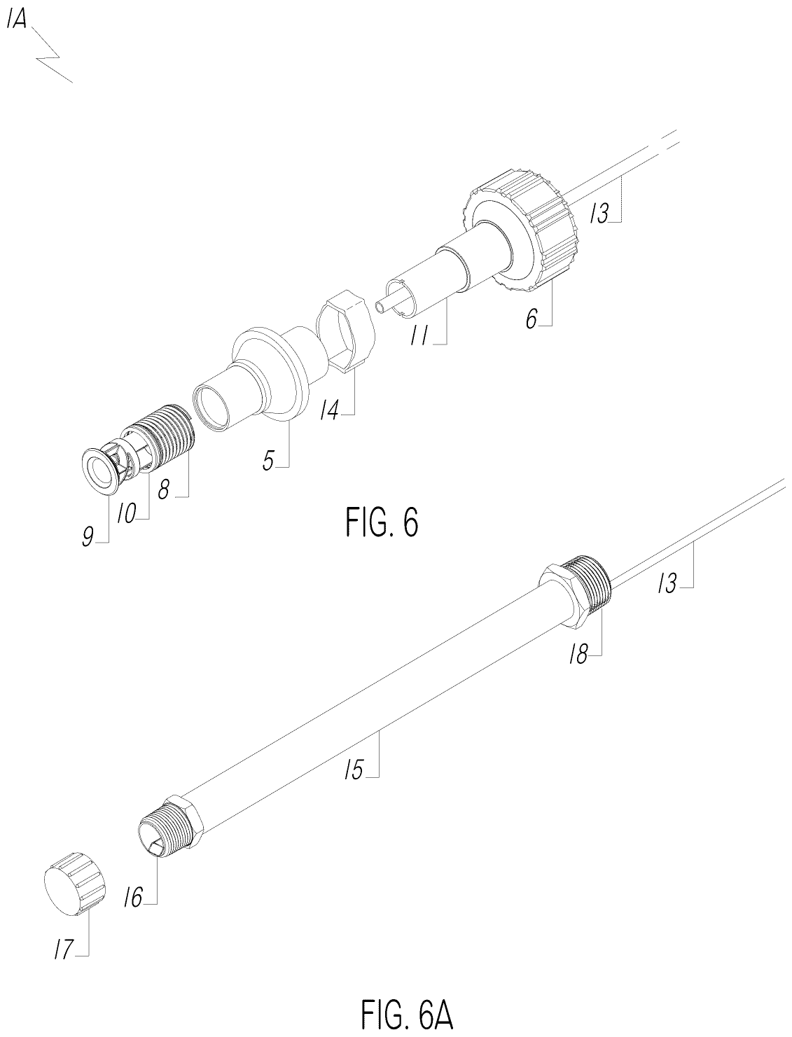

FIG. 6 shows an exploded view of a second embodiment of the System 1 comprised of, but not limited to cylindrical-shaped stopper 9 with hooks on a distal end engaging metal spring 8 there inside along with O-ring 10 and shim 14. Compression collar 5 engaging said stopper 9, O-ring 10 and spring 8 and having a shape that engages tank necks that when compressed allows apertures in stopper 9 to be exposed for fluid flow and air equalization as mentioned. Compression collar 5 is affixed to reservoir 7 with internal threads that engage external threads on said reservoir 7. The compression collar 5 being slidably connected to squeeze ring 14 and reservoir coupling 6 by means of center support 11. Vent tube 13 is positioned inside all the aforementioned elements and secured to one of stopper 9's apertures. When squeeze ring 14 is compressed by a user, it allows compression collar 5 to slide along center support 11 thereby exposing apertures in stopper 9 and allowing for fluid flow and air equalization as mentioned. Conversely, when the System 1 is removed from a tank neck the compression collar 5 is returned to it default position covering apertures in stopper 9 and halting both fluid and air flow into apertures on stopper 9. When fluid fills a tank, the level reaching nozzle 1A and preventing air from equalizing reservoir 7 and halting flow automatically. FIG. 6A shows a third embodiment of the system comprising flexible tube 15 having a nozzle coupling 16 with external threads and aperture and screw cap 17 with internal threads on one distal end and a reservoir coupling 18 with external threads on another distal end. Vent tube 13 being threaded inside tube 15 and affixed to said nozzle coupling 16. When fluid fills a tank, the level reaching nozzle coupling 16 and preventing air from equalizing the reservoir and halting flow automatically.

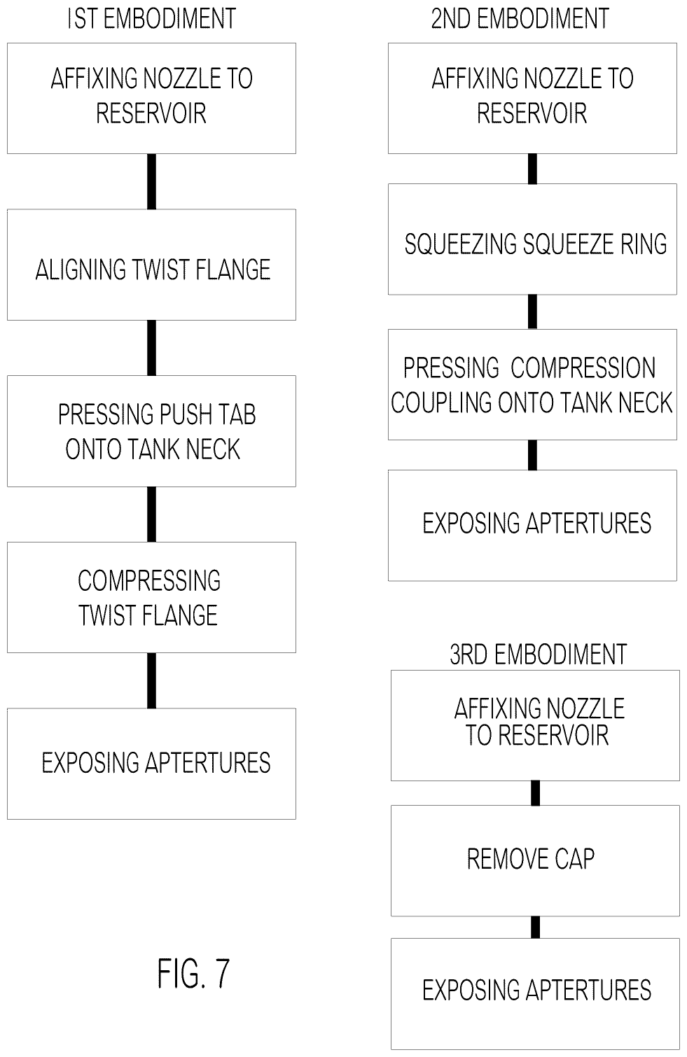

FIG. 7 shows a representative view of the System methods that include but are not limited to the following steps for the first embodiment: affixing the nozzle to the reservoir by twisting the reservoir coupling; aligning twist flange by matching indicia on the twist flange to indicia on the center support; pressing the push tab on twist flange onto the neck of a tank; compressing the twist flange; exposing apertures on stopper and allowing fluid to flow and air to equalize. FIG. 7 also shows a representative view of the System methods that include but are not limited to the following steps for the second embodiment: affixing the nozzle to the reservoir by twisting the reservoir coupling; squeezing the squeeze ring and sliding it onto reservoir coupling; pressing the compression coupling onto the neck of a tank; exposing apertures on stopper and allowing fluid to flow and air to equalize. Finally, FIG. 7 showing a third embodiment of the system having a method that includes the steps of affixing the reservoir coupling to a reservoir, removing the screw cap and exposing aperture in nozzle coupling and allowing fluid to flow and air to equalize.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1) A fluid dispensing system, comprising:
a) a reservoir having a shape of a conventional gas jug with a handle mounted along the longitudinal axis of the reservoir for ergonomic handling;
b) a nozzle affixed to the reservoir, wherein the nozzle is configured to press against a gas tank neck;
c) a vent tube integrated within the nozzle and reservoir to allow air equalization during fluid flow;
d) a compression collar pivotably engaging a reservoir coupling, wherein the compression collar can be compressed onto the reservoir coupling to allow fluid flow and air equalization; and
e) a stopper within the nozzle, configured to halt fluid flow automatically when the fluid level in the tank reaches the nozzle and prevents air from entering the reservoir, wherein the nozzle can be of a large diameter suitable for fitting inside a standard vehicle gas tank neck or of a small diameter suitable for fitting inside a small engine gas tank neck.

2) The fluid dispensing system of claim 1, wherein the nozzle further comprising:
a) a cylindrical-shaped stopper with hooks on a distal end engaging a metal spring inside the nozzle;
b) an O-ring and a shim engaged by the stopper and spring; and
c) a vent tube connected to one of the stopper's apertures.

3) The fluid dispensing system of claim 1, wherein a first embodiment includes:
a) a twist flange having a grip relief and push tab, the twist flange is slidably connected to the reservoir coupling via a center support;
b) the twist flange and center support include indicia for alignment; and
c) the twist flange is compressed to expose apertures in the stopper for fluid flow and air equalization.

4) The fluid dispensing system of claim 3, wherein the twist flange is connected to the reservoir coupling by means of a slot and center support, allowing for a secure connection that exposes the stopper's apertures for fluid flow when aligned and compressed.

5) The fluid dispensing system of claim 1, wherein a second embodiment includes:
a) a squeeze ring allowing a user to slide the compression collar onto the reservoir coupling; and
b) the compression collar can be pressed onto a tank neck to expose apertures in the stopper for fluid flow and air equalization.

6) The fluid dispensing system of claim 5, wherein the nozzle includes:
a) squeeze ring and compression collar assembly includes a center support, allowing the compression collar to slide along the center support to expose apertures in the stopper for fluid flow when the squeeze ring is compressed by a user.

7) The fluid dispensing system of claim 1, further comprising a third embodiment comprising:
a) a flexible tube having a nozzle coupling with external threads and aperture and screw cap with internal threads on one distal end and a reservoir coupling with external threads on another distal end; and
b) a vent tube being threaded inside tube and affixed to said nozzle coupling.

8) A method of dispensing fluid in a first embodiment, comprising the following steps:
a) providing the fluid dispensing system of claim 1;
b) affixing the nozzle to the reservoir by twisting the reservoir coupling;
c) aligning the twist flange by matching indicia on the twist flange to indicia on the center support;
d) pressing the push tab on the twist flange onto the neck of a tank; and
e) compressing the twist flange to expose apertures on the stopper and allowing fluid to flow and air to equalize.

9) A method of dispensing fluid in a second embodiment, comprising the following steps:
a) providing the fluid dispensing system of claim 1;
b) affixing the nozzle to the reservoir by twisting the reservoir coupling;
c) squeezing the squeeze ring and sliding it onto the compression coupling;
d) pressing the compression coupling onto the neck of a tank; and
e) exposing apertures on the stopper to allow fluid to flow and air to equalize.

10) A method of dispensing fluid in a third embodiment, comprising the following steps:
a) providing the fluid dispensing system of claim 1;
b) affixing the reservoir coupling to a reservoir;
c) removing the screw cap; and
d) exposing aperture in nozzle coupling and allowing fluid to flow and air to equalize.

11) The methods of claim 8, wherein the fluid flow is automatically halted when the fluid level in the tank reaches the nozzle, preventing air from equalizing the reservoir.

12) The methods of claim 9, wherein the fluid flow is automatically halted when the fluid level in the tank reaches the nozzle, preventing air from equalizing the reservoir.
